(19) United States
(12) Patent Application Publication
(10) Pub. No.: US 2006/0011523 A1
(43) Pub. Date: Jan. 19, 2006

(54) Water filter cartridge comprising an exchangeable testing unit that contains a conductance sensor

(76) Inventors: Harald Schrott, Lindau (DE); Andreas Wawrla, Widnau (CH); Klaus Zucholl, Mannheim (DE)

Correspondence Address: William D Breneman;Breneman & Georges, 3150 Commonwealth Avenue, Alexandria, VA, 22305, US

(21) Appl. No.: 10/509,880

(22) PCT Filed: Apr. 4, 2003
(86) PCT No.: PCT/DE03/01126

§ 371 Date: Aug. 16, 2005

(30) Foreign Application Priority Data
Apr. 4, 2002 (DE) 102 14 846.5

(51) Int. Cl. B01D 35/14

(52) U.S. Cl. 210/85; 210/96.1; 210/94

(57) ABSTRACT

A water filter cartridge is proposed that is intended especially for treating drinking water in beverage machines or drinking water devices, which includes a replaceable control unit to monitor the condition of the water filter cartridge (1). The water filter cartridge according to the invention is intended to make possible reliable monitoring of its condition. This is accomplished according to the invention in that the control unit includes a sensor unit (11) with at least one conductance sensor (13, 14).

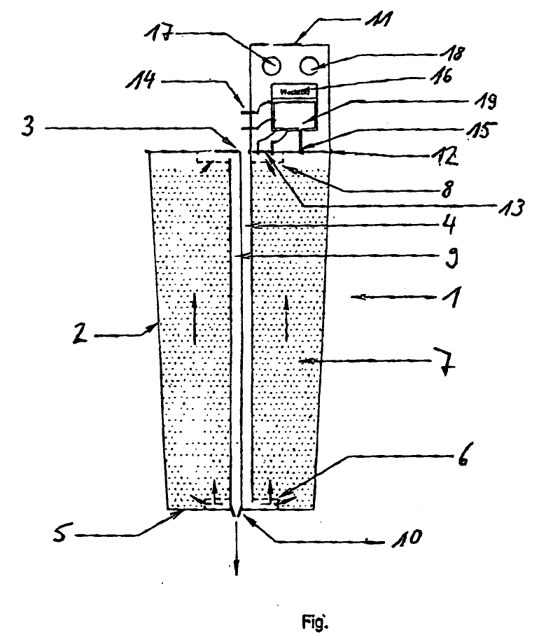

The invention concerns a water filter cartridge according to the preamble of claim 1.

As a rule, filter cartridges for water treatment contain materials to absorb odors and flavors (activated charcoal) and ion exchangers to remove all or some hardness minerals and heavy metals from the water.

These materials have a limited life, which depends first on their absorption or exchange capacity, and second on their resistance to microbial colonization.

If the water composition is known, the filter life can be determined from the water throughput. Experience has shown that given the resistance to microbial colonization of typical filter materials, they have a service life of a few weeks. Therefore, it is sensible to monitor filter cartridges with regard to the water throughput, water quality, and how long they are used.

For example, commercially available coffee machine water filter cartridges have become known which have a built-in water meter, as have water filter cartridge cans with timing modules.

Furthermore, the publication US 60 24 867 has disclosed a water filter cartridge for use in the household which has a replaceable control unit to monitor the condition of the water filter cartridge. It is based on the time during which water flows through the filter unit. This time measurement, or rather the quantity of water which is calculated from it, is used to draw conclusions about the degree of exhaustion of the filter cartridge.

However, this prior art has the disadvantage that the degree of exhaustion of the filter cartridge depends not only on the amount of water purified, but rather also on other variables, for example how dirty the unpurified water is, the temperature, etc.

Therefore, this invention has the task of proposing a water filter cartridge of the type mentioned at the beginning which allows reliable monitoring of the condition of the water filter cartridge.

This task is solved by a water filter cartridge having the features of claim 1.

The measures mentioned in the subordinate claims enable advantageous embodiments and further developments of the invention.

Accordingly, a water filter cartridge according to the invention is characterized in that the control unit includes a sensor unit with at least one conductance sensor. A conductance sensor can perform different measurements which improve the determination of the degree of exhaustion of the filter cartridge.

Thus, for example it is possible to perform a conductance measurement in the filter bed, i.e., in the area of the filter cartridge where the filter material is located. This conductance depends on the condition, and thus on the degree of exhaustion, of the filter cartridge.

In another embodiment of the invention the conductance sensor is provided to measure the pure water quality. The filter cartridge's remaining activity can be monitored directly, and thus independently of other influencing variables, on the basis of the quality of the pure water, i.e., the water that has been purified. If the quality deteriorates, it is assumed that the filter cartridge is losing its activity or that it is exhausted, so that it must be replaced.

Such a conductance sensor, which measures the conductivity or conductance of the pure water through two or more electrodes projecting into the pure water, for example, represents a comparatively simple solution for measuring the pure water quality. Corresponding fluctuations in the conductance of the pure water make it possible to draw direct conclusions about the activity of the filter cartridge.

It is advantageous for the sensor unit to have sensor elements which project into the housing of the filter cartridge. This makes it possible to measure the pure water quality immediately after it exits from the filter material of the filter cartridge. This largely excludes interfering factors due to subsequent flow of the water.

In order to arrange the sensor elements in a corresponding way, a further development of this embodiment provides at least one passage or at least one break point where one or more sensor elements can pass through. Such passages or break points make it easier to install the sensor unit according to the invention with sensor elements projecting into the filter cartridge.

In a preferred embodiment, these openings are sealed by corresponding sealing elements, so that there are no leaks at the place where the sensor elements pass through.

In a special embodiment of the invention, the housing wall of the filter cartridge can have, at the place provided for the sensor elements to pass through, an elastic sealing material, e.g., an elastomer. It is then possible to stick needle-shaped electrodes, for example, through this sealing material, while maintaining a sealing form fit with the material.

In a further development of the invention, an additional measurement is made of the quality of the raw (untreated) water. This measurement can also be made, for example, by measuring the conductance of the raw water, i.e., the water that has not been purified, before it enters the filter cartridge.

Measuring the quality, that is the conductance, of the raw water makes it possible to draw other conclusions about the degree of exhaustion of the filter cartridge. In particular, measuring the quantity of water purified makes it possible, by taking into account the differences between the quality of the raw water and the quality of the pure water, to determine the load on the filter cartridge from the quantity of substances absorbed or exchanged.

For such a determination it is preferable to provide a corresponding electronic evaluation unit.

To measure the quality of the raw water, a special embodiment provides two electrodes on the outside of the sensor unit. This is especially advantageous with filter cartridges which are used in a water storage tank. In this case, the electrodes on the outside of the sensor unit can be wetted by the water located in the water storage tank.

In a further development of the invention, the sensor unit also includes a temperature sensor. The temperature measurement makes it possible to take corresponding temperature effects into account when determining the condition of the filter cartridge.

It is also preferable for the sensor unit to have a timing element, so that it is possible to measure time. Thus, in addition to determining the condition of the filter on the basis of the determination of the water quality, it is also possible to provide a time-dependent filter change. This can be done especially in connection with the measured water temperature. This ensures that in any case the filter is changed on time if there is microbial colonization, for example, or if there are other reasons which cannot be detected by sensor measurement of water quality, or which can be detected only with difficulty.

It is advantageous for the sensor unit to have a display which at least indicates when a filter change is necessary. In a more elaborate embodiment, it is also possible for other information to be displayed, e.g., the degree of exhaustion or the expected remaining life of the filter cartridge. This information can be displayed in a different manner.

In addition to an optical display, it is also conceivable to use an acoustic signal transmitter, for example. In order to make it as simple as possible to replace the sensor unit or change the water filter cartridge, it is preferable for the filter cartridge and/or the sensor unit to have corresponding fastening elements on them. Such fastening elements can be provided in the form of catches, which make it simple for the sensor unit to be clipped on or latched into the filter cartridge. A catch is one example of a way that the sensor unit can be fastened to the filter cartridge which allows it to be mounted and removed again without great effort, and especially without tools.

The filter cartridge according to the invention is preferably used in beverage machines, especially coffee vending machines or drinking water devices, where it can be used in a water storage container, for example.

An embodiment of the invention is shown in the drawing, and will be explained in detail below using the Figure.

The single FIGURE is a schematic illustration of the structure of a possible embodiment of the invention.

The single FIGURE shows a filter cartridge 1 with a housing 2. Water that is to be purified, i.e., raw water, goes through the water inlet 3 and a supply pipe leading downward into the area of the floor 5 of housing 2. There it goes through a sieve 6 into the filter granulate 7 and flows up through it. The pure water can exit from filter granulate 7 through a top sieve 8, and it goes into outlet pipe 9, which also leads down. The purified water flows through outlet pipe 9 to water exit 10.

A sensor unit 11 is snapped into a peripheral annular groove 12 [to connect it] with housing 2 of filter cartridge 1. When this is done, two electrodes 13 penetrate housing 2 and project inward into filter cartridge 1. There they come into contact with the purified water exiting from sieve 8.

Two more electrodes 14 are mounted on the outside of sensor 11, and accordingly come into contact with the water that has not been purified, the raw water in front of water inlet 3.

A temperature probe 15 is also provided, which is in thermal contact with filter cartridge 1.

Sensor unit 11 also has a display, a pushbutton 17, and a battery 18. The central evaluation electronics 19 is only indicated in the schematic illustration shown in the figure.

Sensor unit 11 is able to measure the conductance or conductivity of the pure water through electrodes 13. Electrodes 14 also allow the conductivity of the raw water to be measured. This makes it possible to take into consideration the difference between the two conductance values when determining the degree of exhaustion of filter cartridge 1.

Display 16 makes it possible to transmit information to an operator, in particular to indicate that a filter change is necessary.

Pushbutton 17, which is drawn in as an example of any kind of input element, makes it possible to input additional information or to adjust the evaluation electronics 19.

For example, it is possible to control various operating modes or also to input values for certain variables to be taken into account when evaluating the sensor results, e.g., a filter type or the like.

Sensor unit 11 is able, through electrodes 13, 14, to recognize whether it has been mounted on, i.e., in this embodiment whether it has been clipped onto, a new filter cartridge. This can start an internal timer (not shown in detail). This in turn makes it possible to indicate a time-dependent filter change, which can, if necessary, take into consideration the water temperature measured with the temperature probe 15.

Sensor unit 11 is also able to recognize, through electrodes 13, 14, the degree of exhaustion of filter cartridge 1. Depending on the case, it can already be sufficient to measure the conductivity of the pure water and use fluctuations in this value to make statements about the degree of exhaustion of filter cartridge 1. In this embodiment, the conductivity of the unpurified raw water is also measured through electrodes 14 before it enters into filter cartridge 1. The difference in conductivity of the filtered and unfiltered water can be taken into consideration when determining the [degree of] exhaustion of the filter cartridge. Taking account of this difference makes it possible to eliminate sources of error.

Of course sensor unit 11 can also have a different geometric design, e.g., in the form of a plate with an opening for the water inlet 3 and display and operator controls on top. Instead of or in addition to display 16, it is also possible to provide another optical (e.g., LED) or acoustic signal unit.

The filter cartridge can also have a different design. It can, e.g., have a bottom water inlet opening and only a downward outlet pipe, etc.

The essential feature of the invention is that it has a sensor unit which includes a conductance sensor to monitor the condition of the water filter cartridge.

List of Reference Numbers
1 Filter cartridge
2 Housing
3 Water inlet
4 Inlet pipe
5 Floor
6 Sieve
7 Filter granulate
8 Sieve
9 Outlet pipe
10 Water outlet
11 Sensor unit
12 Annular groove
13 Electrodes
14 Electrodes
15 Temperature probe
16 Display
17 Pushbutton
18 Battery
19 Evaluation electronics

What is claimed is:

1. Water filter cartridge, especially for treating drinking water in beverage machines or drinking water devices, with a replaceable control unit to monitor the condition of the water filter cartridge, characterized in that the control unit includes a sensor unit (11) with at least one conductance sensor (13, 14).

2. Water filter cartridge according to claim 1, characterized in that the conductance sensor (13) is provided to measure the conductivity of the filtered water.

3. Water filter cartridge according to one of the preceding claims, characterized in that sensor elements (13) are provided which project into the housing (2) of the filter cartridge (1).

4. Water filter cartridge according to one of the preceding claims, characterized in that at least one passage and/or at least one break point are provided for one or more sensor elements (13) to go through.

5. Water filter cartridge according to one of the preceding claims, characterized in that a conductance sensor (19) is provided to measure the quality of the unfiltered water.

6. Water filter cartridge according to one of the preceding claims, characterized in that an electronic evaluation unit (19) is provided.

7. Water filter cartridge according to one of the preceding claims, characterized in that the electronic evaluation unit (19) takes into account the difference between at least two conductance values in performing its evaluation.

8. Water filter cartridge according to one of the preceding claims, characterized in that a temperature sensor (15) is provided.

9. Water filter cartridge according to one of the preceding claims, characterized in that a timing element is provided for determining the time.

10. Water filter cartridge according to one of the preceding claims, characterized in that a display (16) is provided for the condition of the water filter cartridge (1).

11. Water filter cartridge according to one of the preceding claims, characterized in that fastening elements (12) are provided to fasten the sensor unit (11) to the filter cartridge (1).

12. Water filter cartridge according to one of the preceding claims, characterized in that at least some of the fastening elements are catches (12).

13. Beverage machine or drinking water device with a drinking water treatment system, characterized in that a water filter cartridge (1) according to one of the preceding claims is provided.
